(19) United States
(12) Patent Application Publication
(10) Pub. No.: US 2003/0145537 A1
(43) Pub. Date: Aug. 7, 2003

(54) Metal building stud and brick tie for a hybrid metal and timber framed building system

(76) Inventor: Geoff Bailey, Nundah (AU)

Correspondence Address: Stephen B. Pokotilow, Stroock & Stroock & Lavan LLP, 180 Maiden Lane, New York, NY, 10038, US

(21) Appl. No.: 10/358,788

(22) Filed: Feb. 4, 2003

(30) Foreign Application Priority Data
Feb. 5, 2002 (AU) PS0317
Feb. 5, 2002 (AU) PS0318
Jun. 27, 2002 (AU) PS3220

(51) Int. Cl. E06B 1/04; E04H 3/00; E04H 5/00; E04H 14/00

(52) U.S. Cl. 52/210; 52/238.1; 52/481.1; 52/733.2

(57) ABSTRACT

A hybrid building system using metal studs and brick ties in a timber framed building. The metal stud comprises an elongated metal section including two flanges joined by a web. The elongated metal section may be a C-section or a Z-section. The metal stud comprises foldable tabs at the top and bottom of the stud, a plurality of fastener holes along its length, service apertures along its length, brick tie fixing holes, a plurality of foldable lining spikes along its length and a wall lining sheet support tab at the lower end of said stud. The primary advantage of the invention is that there is an opportunity to utilize the desirable qualities of a steel stud with timber frames, which are more widely used, to create an improved building frame system.

The invention relates to a hybrid building system using metal studs and brick ties in a timber framed building. In particular, although not exclusively, the invention relates-to a metal stud and a brick tie for use in the hybrid building system.

### BACKGROUND TO THE INVENTION

One of the most common building materials in residential and light commercial building construction is timber. Timber is popular because it is easy to use and relatively inexpensive. Notwithstanding the advantages there are a number of problems with timber construction that has led to the development of building systems using alternative materials. These problems include susceptibility to termite attack, variations in timber quality and dimensional accuracy and periodic timber shortages leading to construction delays and cost increases. Timber construction joints are notoriously weak in tension except with the addition of sheet metal bridging connectors which are costly and difficult to install.

As an alternative, one material that has achieved modest popularity is steel. Various steel frame building systems may be found in the literature including, for example, Australian Patent number 590821 in the name of Bryan Howell. This patent describes a system of metal studs, plates and noggins that are assembled using fasteners passed through aligned slots.

Although numerous steel framed building systems have been proposed for residential and light commercial applications, they have failed to achieve wide acceptance, particularly where the framing is assembled on site. The inventor speculates that this is due to the ease of use of timber and the familiarity of tradesman with timber as a building material. Furthermore, metal framing systems dictate the use of metal roof trusses due to the difficulty in effectively connecting timber trusses to steel top plates. Metal roofing systems are more difficult to manufacture and therefore more expensive.

Another popular construction method for the walls of residential and light commercial buildings is brick veneer construction consisting of a timber or steel frame as described above with a single depth outer brick wall. In order to provide structural integrity a method is needed to tie the brick wall to the frame.

Numerous products have been developed for the purpose of providing a connection between a frame and a brick wall. These are variously referred to as brick ties, masonry ties, and masonry anchors. Brick ties developed for connection to timber studs are not well suited for use with metal studs. They must be either screw fixed, pop riveted, welded or bolted to the stud. Specific designs for brick ties intended for connection to metal studs also exist, but these also require screw fixing, riveting, welding or bolting.

For examples of prior art brick ties, reference may be had to U.S. Pat. No. 6,209,281, assigned to Bailey Metal Products Limited that describes a two part brick tie that has an anchor that is screwed to a metal stud and a tie wire that is mortared into the brickwork. Reference may also be had to U.S. Pat. No. 5,636,486, in the name of Hall, which describes a threaded masonry tie that is bolted through a stud with a sealing member to engage the sheathing of the building wall. The other end of the rod is mortared into the brickwork.

It is commonplace to provide a paper or sisal covering over the framework before constructing the brick veneer. This can cause problems in high humidity regions or where moisture can penetrate porous brickwork. Moisture can collect on the brickwork and run down the inside face. If left unchecked the moisture can track along the brick ties to the paper or sisal covered wall studs. As well as saturating the stud covering, the water will wet the studs and eventually wet the interior dry wall lining of the building.

With the present invention there is the opportunity to incorporate the advantages of steel and timber by devising a special steel framing stud that permits construction of a timber and steel hybrid building frame and by devising a special brick tie.

### OBJECT OF THE INVENTION

It is an object of the present invention to provide a new design of a metal stud for a hybrid building system.

It is another object of the invention to overcome the drawbacks of the above described timber frame and steel frame building systems.

It is yet another object to provide a hybrid building system utilizing the new design of metal stud.

It is a further object of the invention to provide a new design of brick tie that is simple to install to metal studs.

It is another object of the invention to provide a brick tie for use with the above metal stud in a hybrid building system, the brick tie being rigid and providing a moisture migration resistant connection between metal studs and brickwork in brick veneer walls of buildings.

Further objects will be evident from the following description.

### DISCLOSURE OF THE INVENTION

In one form, although it need not be the only or indeed the broadest form, the invention resides in a metal stud comprising: an elongate metal section including two flanges joined by a web; flange and web plate tabs formed at each end of the stud, said web plate tabs foldable from a position in a plane of the web to a position generally perpendicular to the web; and one or more further tabs formed along the length of the web for positioning and support of one or more lintels, sills and noggins, said one or more further tabs being formed in the plane of the web but foldable to a position generally perpendicular to the web.

Suitably the elongate metal section is a C-section or Z-section channel.

The web plate tabs are suitably formed in the plane of the web by cutting of the web in the shape of the tab. Scoring or notching of the web along a fold line will facilitate folding of the tab into the position generally perpendicular to the web if the folding operation is performed using hand tools at a building site.

There is a plurality of fastener holes along the stud for fastening of timber to the stud at the tabs and at intermediate positions along the stud. The timber being fastened is typically top and bottom plates, lintels, sills, noggins, or other timber building components. The fastener holes may be indented to take the head of the fastener. Additionally, a knurled or otherwise roughened surface may be provided on areas of the stud to facilitate machine insertion of nails or screws.

The stud preferably also includes service apertures in the web formed at several positions along the length of the stud. The apertures may have rolled edges to prevent damage to pipes and cables.

There may also be a plurality of lining spikes formed in the flanges of the studs and foldable into a position to support wall linings. A wall lining sheet support tab may be provided close to the lower end of the stud.

Preferably there are brick tie fixing holes appropriately spaced along the stud to receive an end of a wire brick tie in brick veneer construction.

In a further form, the invention resides in a hybrid building frame system comprising:

a plurality of metal studs, said metal studs comprising:

an elongate metal section including two flanges joined by a web; flange and web plate tabs formed at each end of the stud, said web plate tabs foldable from a position in a plane of the web to a position generally perpendicular to the web; and one or more further tabs formed along the length of the web for positioning of lintels, sills or noggins, said one or more further tabs being formed in the plane of the web but foldable to a position generally perpendicular to the web;

timber top plates attachable to said metal studs at upper said flange and web plate tabs;

timber bottom plates attachable to said metal studs at lower said flange and web plate tabs; and

timber lintels, sills and noggins attachable between said studs at said one or more further tabs.

The timber components will generally be the same width as the distance between the flanges of the stud. If the timber components are wider they may be stepped down in width at points where they join onto a stud so that a neat fit is formed between the flanges of the stud and the timber.

In a further form, the invention resides in a brick tie for attachment to a metal stud in a hybrid building frame system, said brick tie comprising:

a length of shaped wire including a body, a stud attachment portion at one end of the body, a wall engagement portion at the other end of the body and a moisture elimination portion intermediate the stud attachment portion and the wall engagement portion;

said stud attachment portion consisting of a bent section forming a crank that interlocks with a hole in the stud.

Suitably the stud attachment portion comprises a crank in the form of a first short length extending generally perpendicular to the longitudinal axis of the body of the wire and a second length extending generally parallel to the longitudinal axis of the body of the wire from an end of the short length distal from the body.

The stud attachment portion may further comprise a third length generally perpendicular to the longitudinal axis of the body of the wire and extending from a free end of the second length.

The wall engagement portion suitably comprises a bent portion adapted to be held in mortar laid between courses of bricks forming a wall.

The wall engagement portion is suitably bent in a wave shape. Alternatively the wall engagement portion may be formed by a single bend in the wire in a plane of a mortar course between bricks forming a wall.

The moisture elimination portion is suitably an N shaped section bent in the wire. In use, the N shaped section is aligned in a vertical plane.

It will be appreciated that there is no specific relationship between the planes of the bends of the stud attachment portion, the plane of the wall engagement portion, and the plane of the moisture elimination portion. However, it is preferable that the stud attachment portion and the wall engagement portion are formed in a generally horizontal plane.

The brick tie is preferably formed from stainless steel wire.

### BRIEF DETAILS OF THE DRAWINGS

To assist in understanding the invention preferred embodiments will now be described with reference to the following figures in which:

FIG. 1 shows a C-section metal wall stud;

FIG. 2 shows a Z-section metal wall stud;

FIG. 3 is an enlarged view of one end of the metal wall stud of FIG. 1;

FIG. 4 shows one end of a metal wall stud with web plate tab folded in;

FIG. 5 shows one end of a metal wall stud with web plate tab folded out;

FIG. 6 is a sketch of part of a metal wall stud showing a lintel tab folded in;

FIG. 7 is a sketch of part of a metal wall stud showing a lintel tab before being folded;

FIG. 8 is a sketch of part of a metal wall stud showing a lintel tab folded out;

FIG. 9 is a sketch of part of a metal wall stud showing noggin tabs folded in;

FIG. 10 is a sketch of part of a metal wall stud showing noggin tabs before being folded;

FIG. 11 is a sketch of part of a metal wall stud showing noggin tabs and a lining sheet fixing spike folded folded out;

FIG. 12 is a sketch of part of a metal wall stud showing a services aperture and a web plate tab folded in;

FIG. 13 is a sketch of part of a metal wall stud showing a services aperture with a web plate tab and a lining sheet support tab folded out;

FIG. 14 shows the construction of part of a wall using a metal wall stud;

FIG. 14A shows the construction of part of a wall using a metal wall stud in an alternative configuration;

FIG. 15 shows the construction of part of a wall using a metal wall stud in a further alternative configuration;

FIG. 16 shows the construction of a part of a residential building using the metal wall studs;

FIG. 17 shows the use of tie wire to tie bricks to the wall studs in a brick veneer construction;

FIG. 18 shows one end of a metal wall stud with web plate tab folded out and flange plate tab enclosing a wall plate;

FIG. 19 shows an alternate configuration of connecting a metal wall stud to a wall plate;

FIG. 20 shows another configuration of a connecting a metal wall stud to a wall plate; and

FIG. 21 shows a further configuration of connecting a metal wall stud to a wall plate.

FIG. 22 shows a brick tie attached to a stud and engaging a wall;

FIG. 23 shows a first embodiment of a brick tie engaging the web of a metal stud;

FIG. 24 shows a perspective view of the brick tie of FIG. 23;

FIG. 25 shows a second embodiment of a brick tie engaging a flange of a metal stud;

FIG. 26 shows a perspective view of the brick tie of FIG. 25;

FIG. 27 shows a third embodiment of a brick tie engaging the web of a metal stud;

FIG. 28 shows a perspective view of the brick tie of FIG. 27;

FIG. 29 shows a fourth embodiment of a brick tie engaging a flange of a metal stud; and

FIG. 30 shows a perspective view of the brick tie of FIG. 29.

### DESCRIPTION OF THE PREFERRED EMBODIMENT

In describing different embodiments of the present invention common reference numerals are used to describe like features.

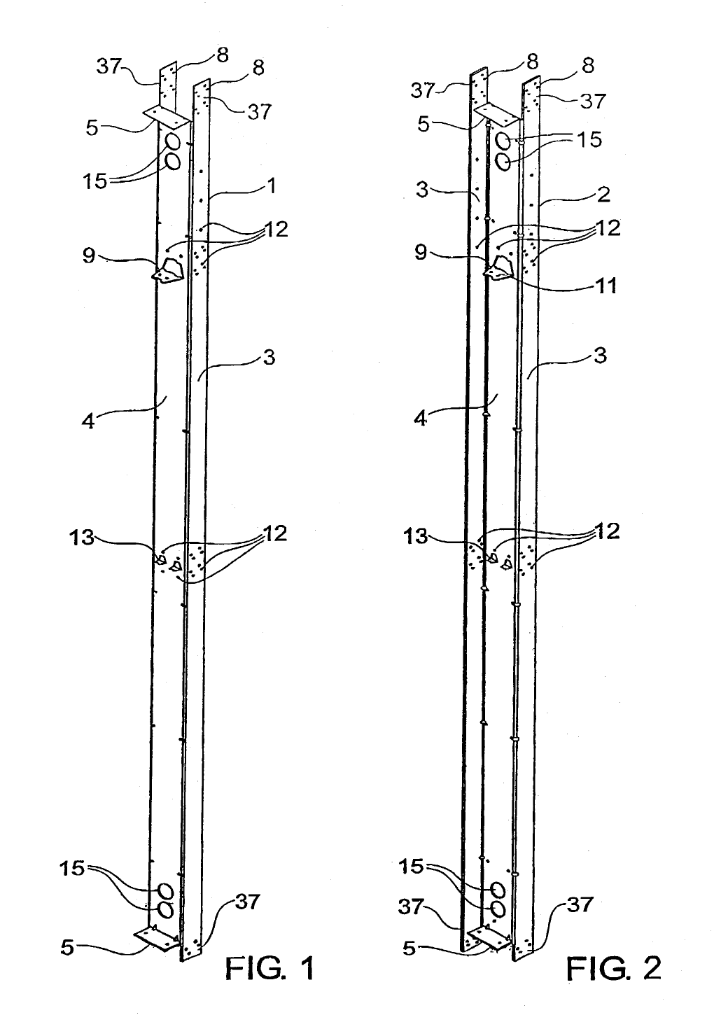

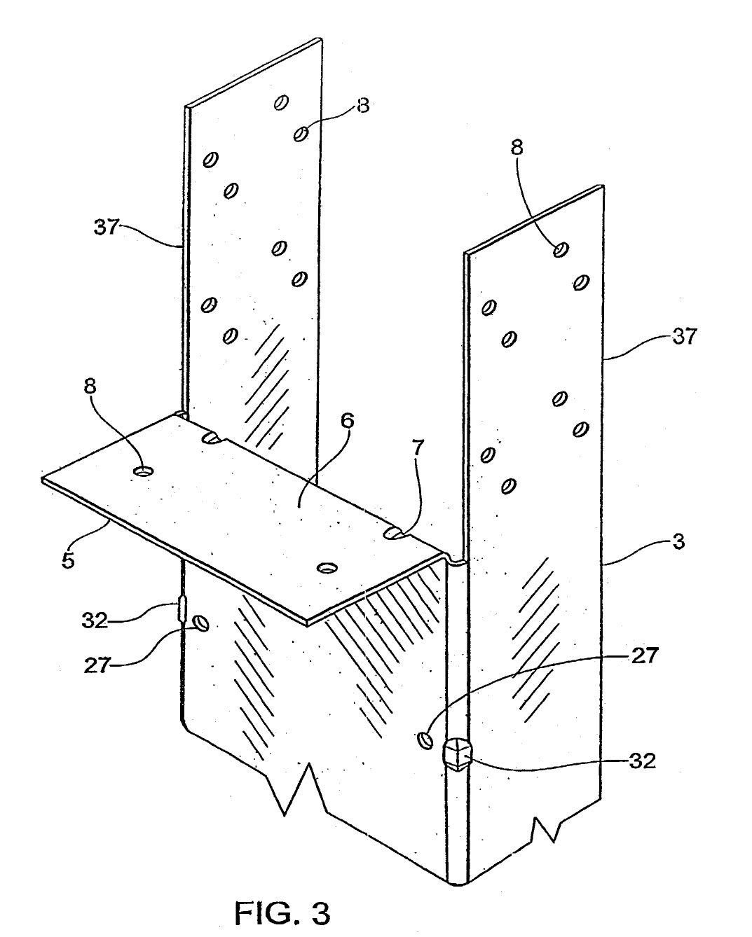

There is shown in FIG. 1 a steel wall stud 1 formed from a C-section elongate channel member. Another steel wall stud 2, formed from a Z-section elongate channel, is shown in FIG. 2. The construction of each stud is the same except for the channel section used. The stud may be roll-formed, pressed or otherwise folded to produce a channel section with parallel flanges 3 and a joining web 4. At each end of stud 1 is formed a foldable web plate tab 5 and two flange tabs 37. The web plate tab is formed in the plane of the web 4 by cutting the join between the flange 3 and the web 4. As shown in FIG. 3 the tab 5 is folded out at approximately right angles to the web at fold line 6. Two indented ribs 7 act to lock the web plate tab in the folded position.

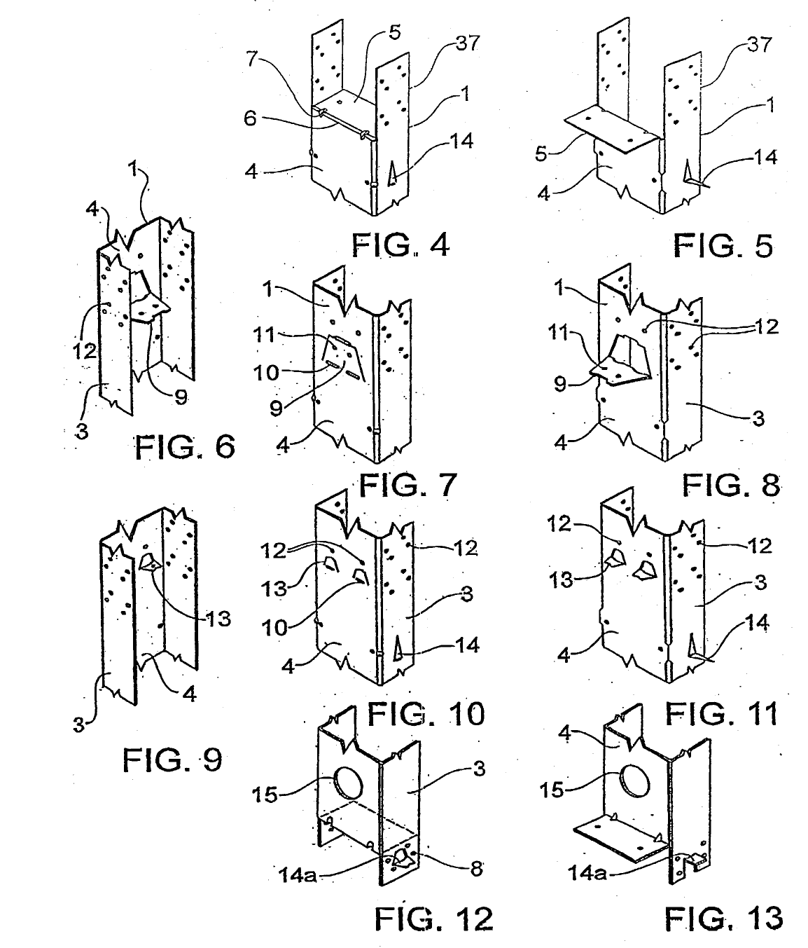

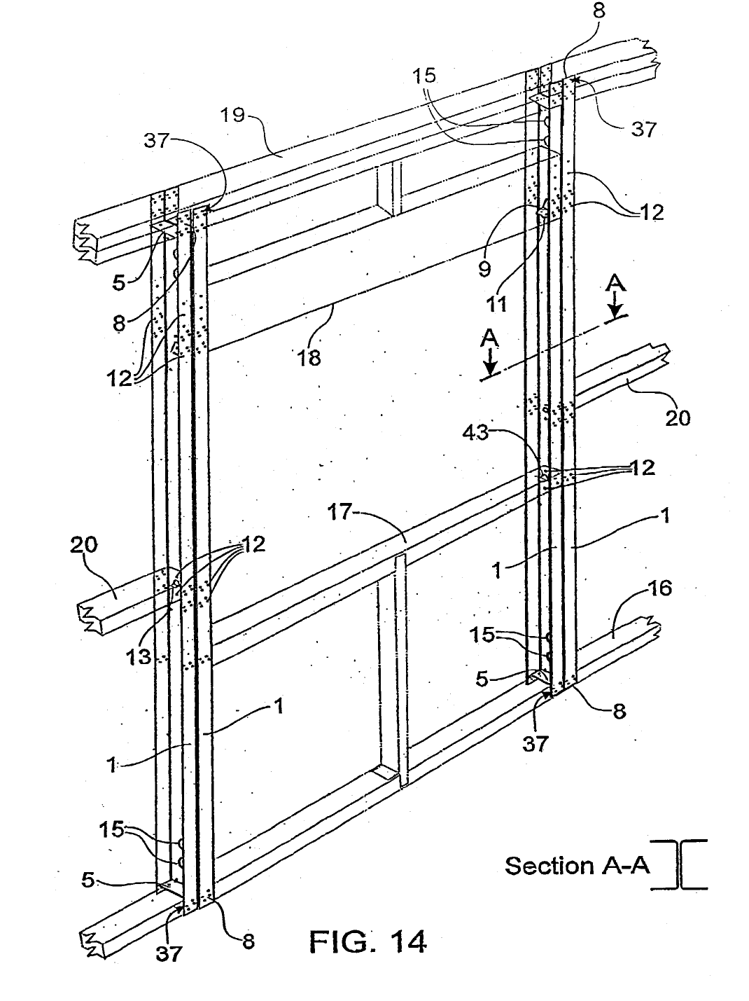

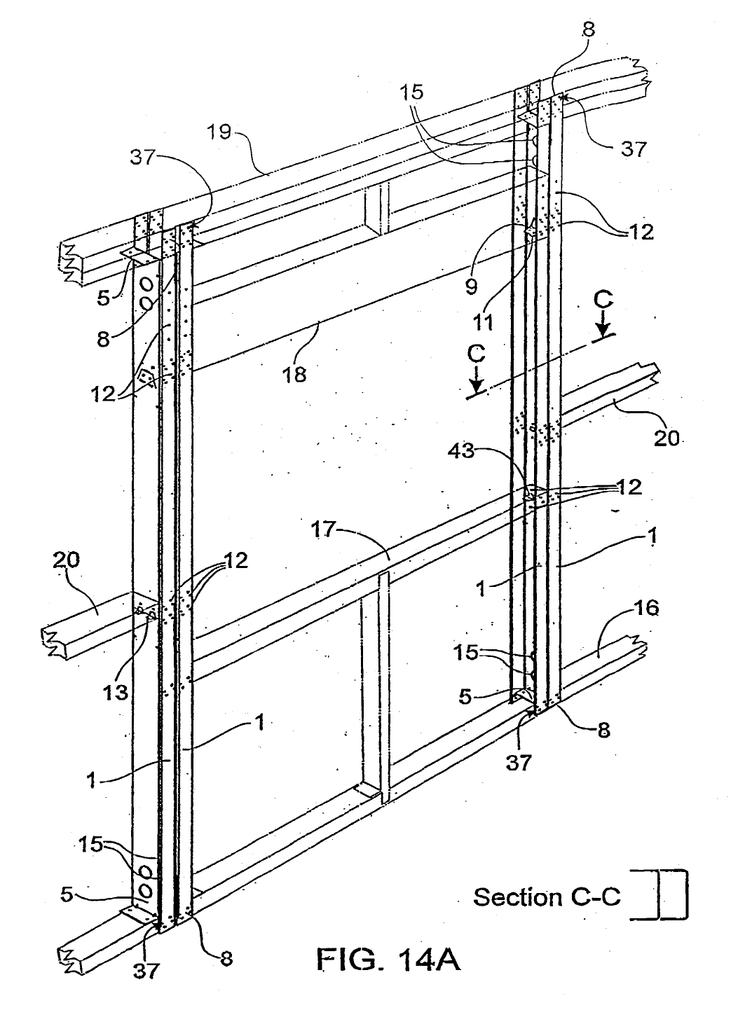

As seen in FIG. 3, the web plate tab 5 forms a seat for the top or bottom plate of a wall frame, as shown and described later with reference to FIGS. 14-16. Fasteners, such as nails or screws, fasten the wall stud 1 to the top and bottom plates through holes 8 provided in the flange tabs 3 and web plate tab 5. The web plate tab 5 may be folded in as shown in FIG. 4, or out as shown in FIG. 5.

In one embodiment as shown in FIG. 14, the top and bottom plates are selected to have a width that will fit between the flange tabs 37. In this manner the metal wall stud 1 will seat comfortably onto the bottom plate and the top plate will seat comfortably into the top of the metal wall stud. Similarly the lintels, sills and noggins are selected to have a width that will fit neatly between the flanges 3.

In another embodiment the width of the wall plates, lintels, sills and noggins are selected to be the same as the distance between the outer surfaces of the stud flanges. In this embodiment the plates, lintels, sills and noggins must be stepped down in width in the region where they join onto the stud so they can fit between the stud flanges.

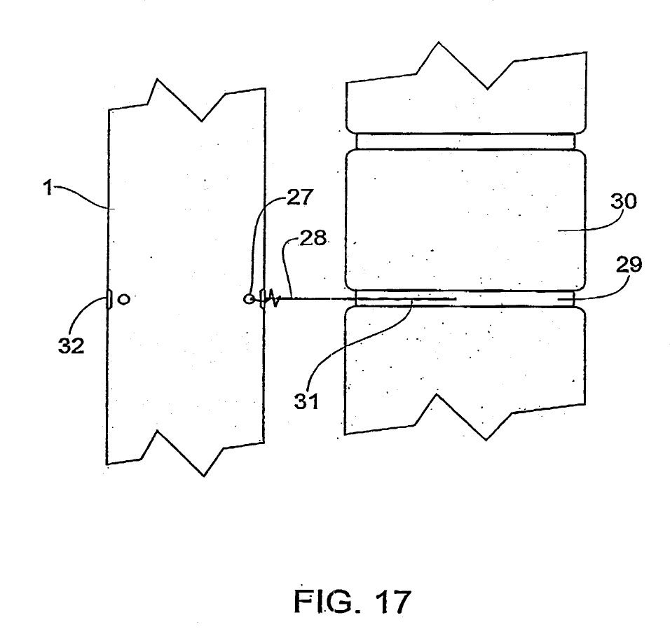

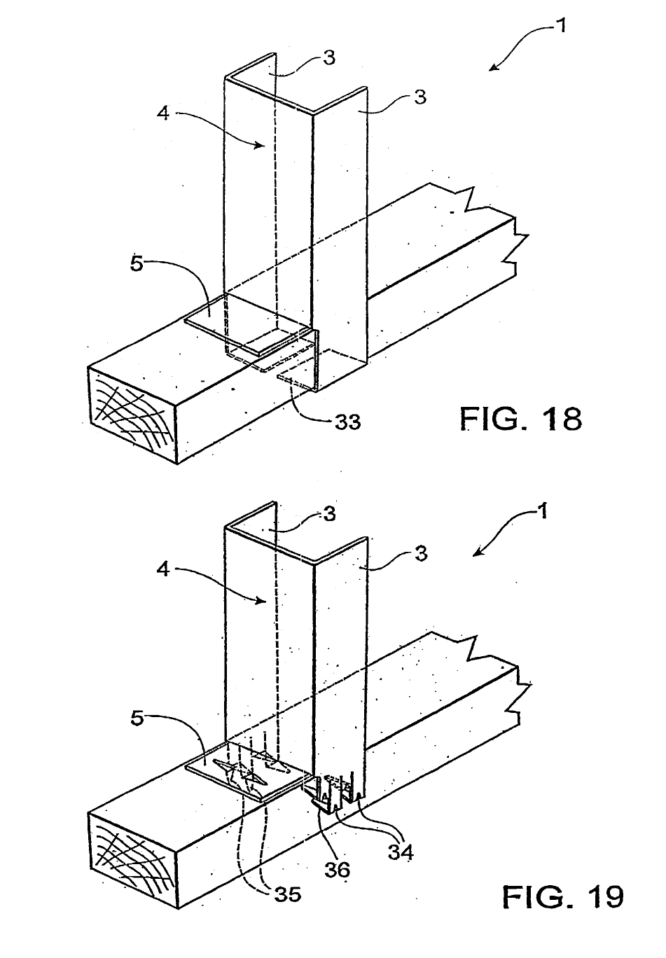

In a further embodiment, as seen in FIG. 18, the wall stud 1 has a web plate tab 5 folded to form a seat for a top or bottom plate of a wall frame similar to that shown in FIG. 3. The wall stud 1 has flange plate tabs 33 formed as extensions to the flange tabs 37. They extend beyond the wall plate and are folded around the wall plate. In this manner, the metal wall stud will encase and attach to the wall plate. The web plate tab 5 is attached to the wall plate by nails, screws, bolts or nail tooth spikes as described in the embodiment with reference to FIG. 3. The flange plate tabs 33 and flange tabs 37 as shown in FIG. 18 may have nails, screws or nail tooth spikes for additional attachment to the wall plate.

In FIG. 19 there is shown an alternate embodiment of securing a wall plate to the wall stud 1. Plate 5 is provided with a plurality of nail tooth spikes 35 formed integrally with the tab. Flange tabs 34 formed in the plane of the flange 3, extend part of the way across the wall plate unlike the embodiment shown in FIG. 18 which extends past the wall plate. The flange tabs 34 in the present embodiment are provided with a plurality of nail tooth spikes 36 formed integrally with the tab. During assembly, the flange tabs 34 must be folded back so the wall plate can be inserted between the spikes 36. The nail tooth spikes 35 and 36 are forced into the wall plate to connect the wall stud 1 to the wall plate.

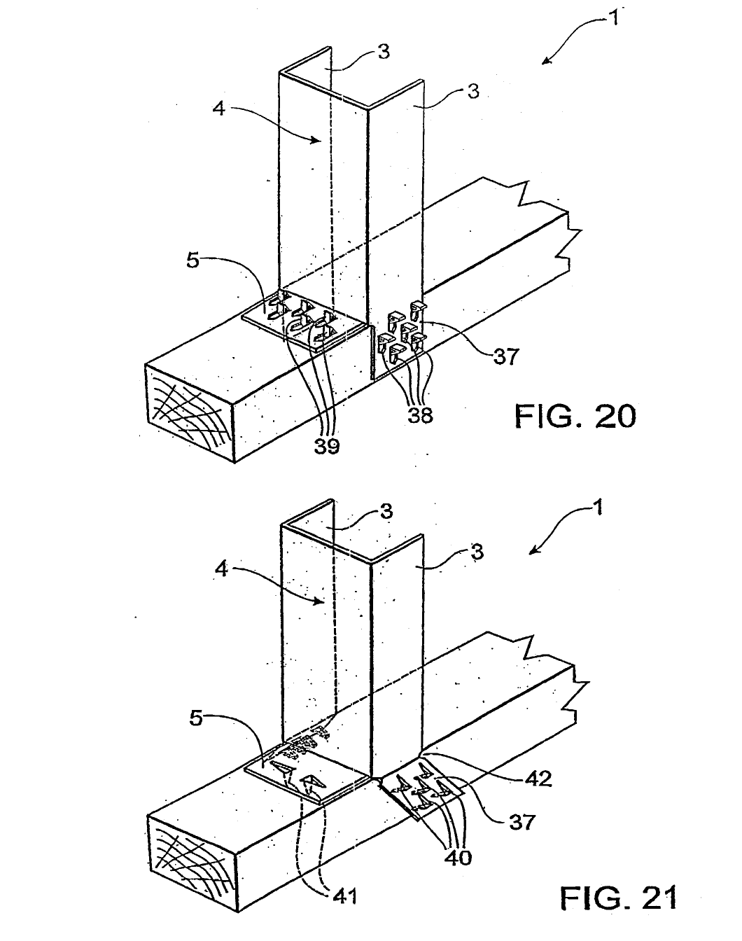

Referring to FIG. 20, there is shown a further embodiment of securing a wall plate to the wall stud 1. Flange tab 37, formed in the plane of flange 3 extends the height of the wall plate, so that the tab 37 is substantially flush with an edge of the wall plate. The flange tab 37 is provided with a plurality of integrally formed offset nail tooth spikes 38 that can be bent inwards into the plane of flange 37, at fold lines at the upper ends of each nail tooth spike. During the assembly of the wall plate and wall stud, the offset nail tooth spikes 38 are forced inwards into the wall plate so that the nail tooth spikes 38 are flush with the flange tab 37.

The web plate tab 5 as shown in FIG. 20 may be provided with a plurality of similar offset nailed tooth spikes 39 to secure the wall plate to the metal wall stud 1.

In a yet further embodiment, there is shown in FIG. 21 the flange tab 37 having a plurality of nail tooth spikes 40 integrally formed therewith. The flange tab 37 extends to the height of the wall plate as in FIG. 20. However, the nail tooth spikes are not offset but protrude from the flange tab 37. Similar nail tooth spikes 41 are integrally formed with web plate tab 5.

During the assembly of the connection of the wall stud 1 to the wall plate, the flange tab 37 is bent outwards at notches 42, to accommodate the wall plate. The nail tooth spikes 40 and 41 are forced into the wall plate to secure the connection of the wall stud 1 to the wall plate.

One particular advantage of tooth nail spikes is that complete wall sections, which use the metal wall studs of the present invention, can be pre-assembled off site using automated machinery with limited nailing required to secure the wall plates to the wall studs.

The metal wall studs 1 may be formed with a range of additional feature tabs to facilitate traditional timber building methods. The feature tabs may be supplied as cut-outs which are left flush with the surface of the web for the builder to fold out on site, as required. Alternatively, they may be supplied already folded out.

If tabs are supplied folded out there will be indents formed along the fold to help hold the tabs in the folded out position. If the tabs are to be folded at the building site there are notches and scores formed to assist the folding.

Referring to again to FIG. 1, there is shown a lintel tab 9 that is cut in the wall stud 1 at a suitable height for supporting a lintel 18, as shown in FIG. 14. For a typical residential building the wall stud 1 may be 2440 mm long and the lintel tab 9 may be at 2100 mm from the bottom of the stud. As with the web plate tab 5, the lintel tab 9 is initially formed in the plane of the web 4, as shown in FIG. 7. Notches 10 provide a fold line so that the lintel tab 9 can be folded in or out. The lintel is fixed to the lintel tab 9 through holes 11 and fixed to the stud web through holes 12. If the lintel tab 9 is folded in as in FIG. 6 the holes 12 in the flange 3 can also be used to fix the lintel to the stud.

Also shown in FIG. 1 are noggin tabs 13 formed part way along the stud 1. As with the lintel tab 9 and plate tab 5, the noggin tabs 13 are initially formed in the plane of the web 4, as shown in FIG. 10. The noggin tabs 13 may be folded in as shown in FIG. 9, or out as shown in FIG. 11. Fasteners pass through holes 12 in the web to fix the noggin to the web of the wall stud 1. Holes 12 in the flanges can be used to fix the noggin to the flanges 3 of the stud 1. The position of the noggin tabs along the length of the stud is selected to correspond to the position of the horizontal join between the wall lining sheets (typically 1200 mm).

To assist with fixing of wall linings to a wall constructed using the metal wall stud 1, there are provided multiple lining spikes 14 that may be folded out from the flange 3. The lining spikes 14 hold the wall lining in position while the stud fixing adhesive cures. The lowermost lining spike 14a (see FIGS. 12 and 13) may be truncated to form a lining sheet support tab that the lining is rested upon to position the lining at the correct height above a ground slab. Typically the lining sheet support tab 14a will be 10 mm from the bottom of the stud.

To allow services to pass through the wall stud 1 one or more service apertures 15 are cut in the lower web of the stud, as shown in FIGS. 1, 2, 12 and 13. The services aperture 15 is formed with rounded edges to avoid damage to the services.

Turning now to FIG. 14, a section of wall is shown that demonstrates the use of the metal wall stud in a hybrid building system. Four metal wall studs 1 are shown seated upon a timber bottom plate 16. Typically the bottom plate is made of termite resistant material. The plate tab 5 on each stud 1 is folded in and the stud is fixed to the bottom plate through holes 8. A window is formed by timber sill 17 that is supported on sill tab 43 and timber lintel 18 supported on lintel tabs 9. The lintel tabs 9 and sill tabs 43 are folded in. The lintel and sill are fixed in position with nails or screws through holes 11 and 12. A timber top plate 19 seats comfortably at the top of the studs 1 on tab 5 that is folded in. The top plate is fixed in position with nails through holes 8.

In the present invention the fastening of the bottom plate 16 and top plate 19 to the stud 1 provides a particularly strong attachment compared to conventional timber construction. The fasteners through the holes 8 in the flange tabs 37 of the stud 1 operate in shear to prevent vertical separation of the components. The fasteners through the holes 8 in the web plate tabs 5 operate in shear to prevent horizontal separation of the components. In contrast, fasteners in conventional timber construction operate primarily in tension and are therefore less effective. The applicants contend that for this reason cyclone bolting that is usually required with conventional timber construction will not generally be required with the hybrid building system.

Similarly, the fastening of the lintel sill and noggins to the studs 1 is achieved through a combination of the fasteners acting in shear with all the benefits as noted above for the top and bottom plate connections to the stud.

In FIG. 19 there is shown an alternate embodiment of securing the bottom plate 16 and top plate 19 to the wall stud 1. Plate tab 5 and flange tabs 34 are provided with a plurality of nail tooth spikes 35 and 36 formed integrally with the tabs. Flange tabs 34 only extend part of the way over either the bottom plate 16 or top plate 19. Nail tooth spikes 35 and 36 are forced into the wall plates upon assembly of the connection of the wall stud 1 to the wall plates.

Referring to FIG. 20, there is shown a further embodiment of securing a bottom plate 16 or top plate 19 to the wall stud 1. Flange tab 37, formed in the plane of flange 3 extends the height of the wall plate, so that the tab 37 is substantially flush with an edge of the wall plate. The flange tab 37 is provided with a plurality of integrally formed offset nail tooth spikes 38 that can be bent inwards into the plane of flange tab 37, at fold lines at the upper ends of each nail tooth spike. During the assembly of the wall plate and wall stud, the offset nail tooth spikes 38 are forced inwards into the wall plate so that the nail tooth spikes 38 are flush with the flange tab 37.

The plate tab 5 as shown in FIG. 20 may be provided with a plurality of similar offset nailed tooth spikes 39 to secure the wall plate to the metal wall stud 1.

In a yet further embodiment, there is shown in FIG. 21 the flange tab 37 having a plurality of nail tooth spikes 40 integrally formed therewith for securing the bottom plate 16 and top plate 19. The flange tab 37 extends to the height of the wall plate as in FIG. 20. However, the nail tooth spikes are not offset but are flush with the flange tab 37. Similar nail tooth spikes 41 are integrally formed with plate tab 5.

During the assembly of the connection of the wall stud 1 to the wall plate, the flange tab 37 is bent upwards at notches 42, to accommodate the wall plate. The nail tooth spikes 40 and 41 are forced into the wall plate to secure the connection of the wall stud 1 to the wall plate.

In a further embodiment, the bottom plate 16 and top plate 19 may be fastened to the stud 1 as shown in FIG. 18. The wall stud 1 has flange plate tabs 33 formed in the plane of flange 3 which extend beyond the wall plate and are folded around the wall plate. The flange plate tabs 33 encase and support the wall plate. Nails or screws may also be used to improve attachment to the wall plate.

To continue the wall construction, in FIG. 14 there is shown back-to-back studs positioned either side of the window. The construction is shown in section A-A. The back-to-back construction provides extra strength and facilitates addition of noggins 20 on noggin tabs 13, usually at a height corresponding to the horizontal join in the internal wall lining. It will be appreciated that the hybrid building system allows noggins to be adjacent the sill if this is necessary for positioning of wall linings. As an alternative the studs either side of the window may be arranged piggy-back fashion as in section C-C of FIG. 14A.

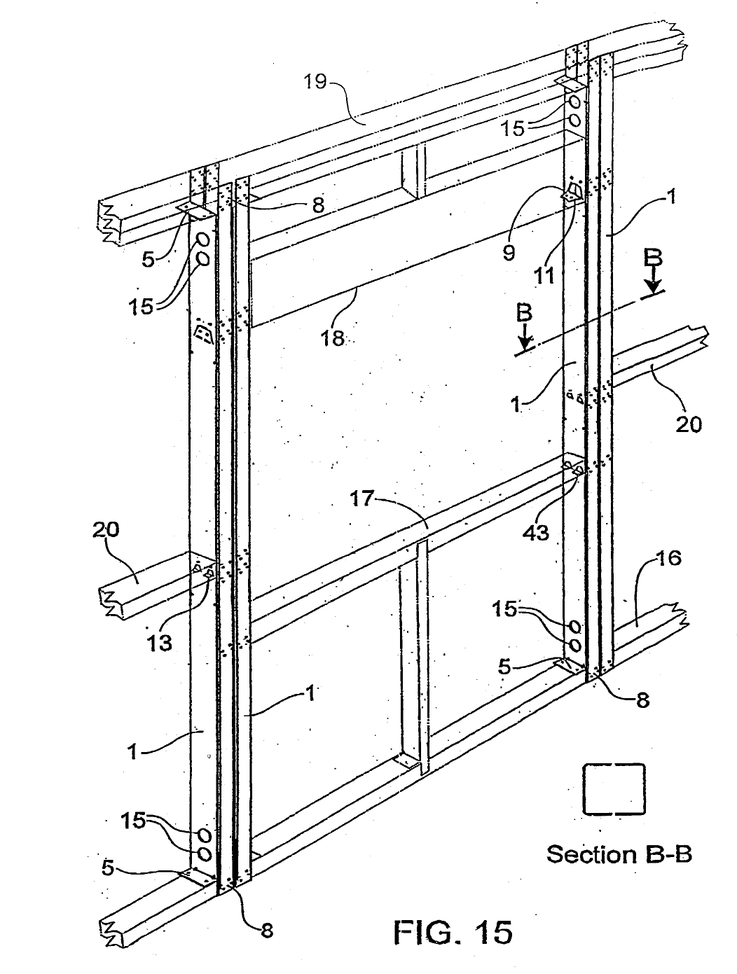

An alternative arrangement is shown in FIG. 15 wherein the pairs of studs either side of the window are arranged face-to-face, as shown in section B-B. This arrangement does not allow the use of fasteners through holes 12 to hold the sill, lintel or noggins, but can provide a clear channel for the passage of services that may be provided through service aperture 15. Where studs are doubled up and there is a cavity between them, they can be locked together and the bending strength of the studs will be enhanced by fixing short timber blocks in the cavity formed between the studs.

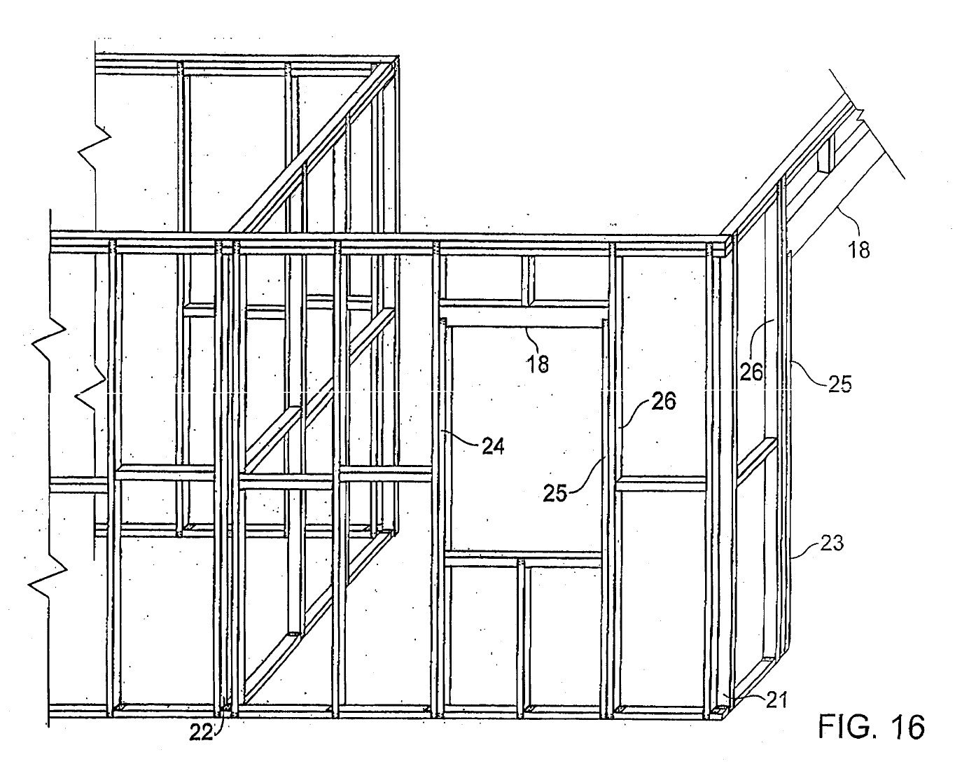

The principles shown in FIGS. 14 and 15 can be applied to construct an entire building. Some of the key methods, such as corner 21, abutting wall 22, door 23 and window 24 are shown in FIG. 16. The door 23 and window 24 are constructed using a variation from the method depicted in FIG. 14. Back-to-back C-section wall studs are used but the inner studs 25 are shorter than the outer studs 26. In this method the lintel 18 seats on plate tab 5 at the top of the stud 25 rather than on lintel tab 9 (see FIGS. 14 and 16).

It is common in timber building construction to finish the outside of the building with a wall of bricks. These bricks are tied to the studs with brick ties that are fixed between the brick courses during construction of the brick wall. As shown in FIG. 17, tie holes 27 are provided in studs 1 to receive the end of brick ties 28. The other end of the brick tie 28 is held by mortar 29 between courses of a brick wall 30. The brick tie 28 is suitably formed from stainless steel wire having conventional corrugated formation 31 at one end.

It is common for paper or sisal to be fixed to the wall frame before construction of the brick wall. The paper makes it difficult to locate the holes 27 for the brick ties 28. To overcome this problem the stud has indents 32 on the edges adjacent the holes 27 as shown in FIGS. 3 and 17.

Improved brick ties in accordance with the present invention suitable for brick veneer construction using the proposed hybrid building system are described below.

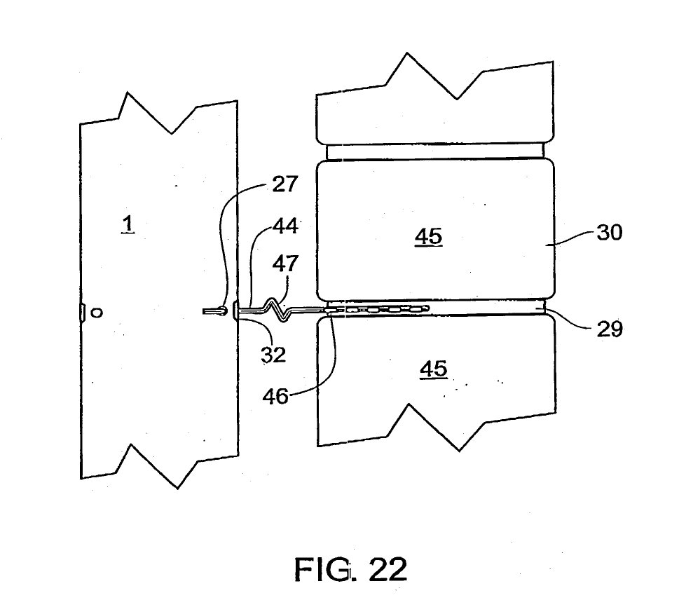

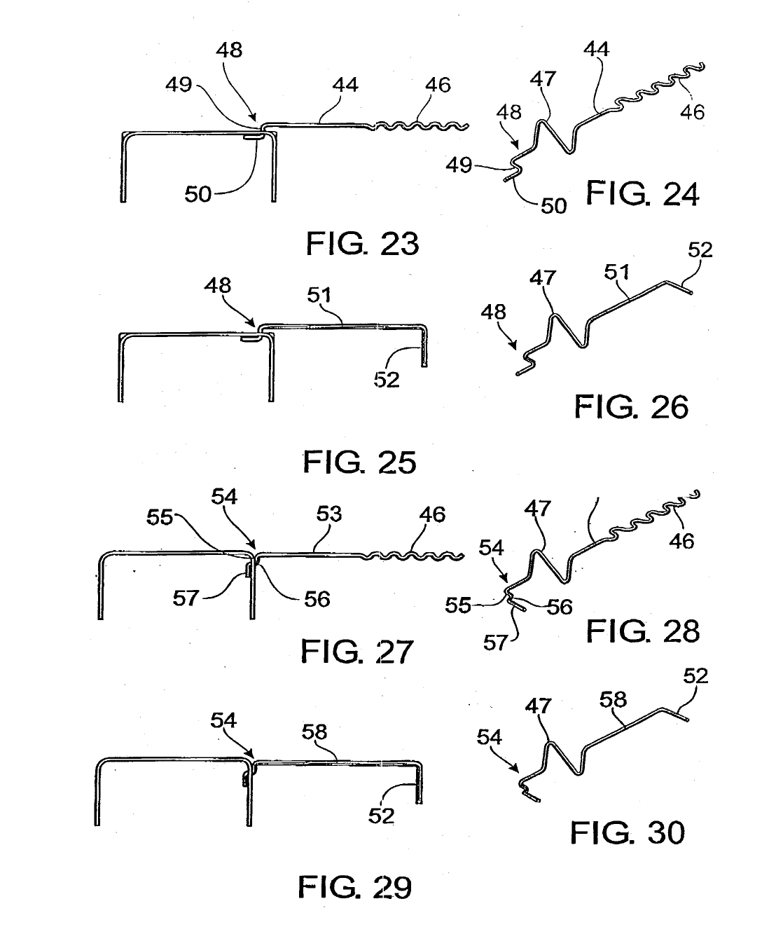

There is shown in FIG. 22 a brick tie 44 attached to a metal wall stud 1 and engaging a brick wall 30. As can be seen most clearly in subsequent figures, the stud 1 has a small hole 27 that receives stud attachment portion 48 of the brick tie 43. These holes maybe drilled on site but are preferably pre-drilled during manufacture of the stud.

The stud attachment portion 48 consists of a short length of wire 49 that is bent at approximately right angles to the body of the brick tie 44. A further bend is made in the wire to form second length 50. The first and second lengths form a crank with the body of the brick tie that securely attaches to the stud once the crank is inserted through the hole 27.

The wall engagement portion 46 is formed as an approximately sinusoidal bend in the opposite end of the wire from the stud attachment portion 48. The wall engagement portion 46 is captured in the mortar 29 between the courses of bricks 45 forming the wall 30.

It is common for a covering of paper or sisal to be applied to the studs 1 on the side facing the brick wall 30. This can make it difficult for the hole 27 to be located for positioning of the brick tie 44. For this reason an indent 32 may be formed in the edge of the stud so the hole location can be found by feeling the indent.

As discussed above, there is a problem with moisture condensing on the inner surface of the brick wall and tracking along the brick tie to the inner wall. If it is not deflected from the tie, the moisture will wet the paper or sisal attached to the face of the stud. Eventually the moisture will wet the interior dry wall lining of the building causing mouldiness and loss of lining board strength in the interior of the building. This problem is addressed by the moisture elimination portion 47 that is formed by a bend in the body of the wire to form a downwards pointing angle that collects moisture which then drips off the brick tie. As clearly seen in FIG. 22, a double-sided moisture elimination portion is preferred so that the brick tie 44 can be installed in either orientation.

The structure of the brick tie 44 is seen most clearly in FIG. 24 which shows the stud attachment portion 48 at one end of the brick tie, the wall engagement portion 46 at the other end of the brick tie, and the moisture elimination portion 47 intermediate the stud attachment portion 48 and the wall engagement portion 46.

A second embodiment 51 of the brick tie is shown in FIGS. 25 and 26. The stud attachment portion 48 and moisture elimination portion 47 are identical to the first embodiment. The second embodiment differs in the wall engagement portion 52 that is formed by a substantially right angle bend in the end of the wire.

A third embodiment 53 of the brick tie is shown in FIGS. 27 and 28. The third embodiment is similar to the first embodiment in formation of the moisture elimination portion 47 and the wall engagement portion 46. However, the third embodiment has a stud engagement portion 54 that is designed to attach to a hole formed in the flange of the stud 1. The stud attachment portion 54 consists of a first length of wire 55 that is bent at approximately right angles to the body of the brick tie 44. A further bend is made in the wire to form second length 56 which seats in the hole in the flange. A third bend forms a third length 57 that rests against the inside of the flange. The first, second and third lengths form a hook that securely attaches to the stud once the hook is inserted through the hole.

A fourth embodiment 58 of a brick tie is shown in FIGS. 29 and 30. In the fourth embodiment the stud attachment portion 54 has the same structure as the third embodiment but the wall engagement portion 14 has the structure of the second embodiment.

In the case of the third and fourth embodiment the location of the hole may be felt through the sisal or paper, thus reducing the need for the indent 32.

The invention offers significant benefits not available with traditional steel stud and building frames. These include:

Permits use of traditional timber frame construction techniques rather than metal working processes to construct building frames with steel studs;

Permits construction of steel stud building frame panels, which have a higher torsional stiffness, than panels made totally from steel channel sections. This feature makes the panel easier to transport and erect;

Enables timber roof trusses to be fitted to a steel stud building frame using traditional timber fastening methods;

Avoids the need to use a steel bottom wall plate while still getting the benefits of having a steel studded building frame. Steel bottom wall plates fixed flat onto a slab are prone to corrode if the slab gets wet; and

Provides a moisture migration resistant connection between steel studs and brickwork in brick veneer walls that often finish the outside of building frames.

The invention offers significant benefits not available with traditional timber stud building frames. These include:

Resists termite infestation by removing vertical timber infestation path, while at the same time permitting normal timber frame construction;

Uses traditional timber building techniques for construction but improves strength of the building frame and reduces the opportunity for defects;

Permits continued use of low cost timber roof frames while providing the benefits of using steel studs;

Reduces the need for cyclone bolting between top and bottom plate due to the strength of metal studs and the strong attachment between the stud and the wall plates;

Reduces the amount of structural timber (a dwindling resource) required in residential and light commercial buildings;

Permits the mainstream of builders, who traditionally build timber framed structures to construct timber-steel composite framed structures which incorporate the described features of the steel frames, while still using traditional timber construction skills; and

Eliminates the need for the labour intensive installation of sheet metal fasteners to connect between studs and wall plates.

The invention has been described in the preferred embodiments with reference to steel studs, however, other materials such as aluminium can also be used without departing from the spirit and scope of the invention.

1. A metal stud comprising:
an elongated metal section including two flanges joined by a web;
flange plate tabs and web plate tabs formed at each end of the stud with said web plate tabs foldable from a position in a plane of the web to a position generally perpendicular to the web; and
one or more further tabs formed along the length of the web for positioning and support of one or more lintels, sills and noggins, said one or more further tabs being formed in the plane of the web but foldable to a position generally perpendicular to the web.

2. The metal stud of claim 1, wherein the elongated metal section is a C-section or Z-section channel.

3. The metal stud of claim 1, wherein the web plate tabs are formed in the plane of the web in the shape of the tab to allow folding perpendicular to the web.

4. The metal stud of claim 1, wherein the stud further comprises a plurality of fastener holes along its length.

5. The metal stud of claim 4, wherein the fastener holes are formed in an indented section.

6. The metal stud of claim 1, wherein the stud further comprises areas of knurled or otherwise roughened surfaces along its length to facilitate machine insertion of nails or screws.

7. The metal stud of claim 1, wherein the web further comprises one or more service apertures formed along the length of the stud.

8. The metal stud of claim 7, wherein the service apertures have rolled edges.

9. The metal stud of claim 1, wherein the flanges further comprise a plurality of foldable spikes that are folded out from the flanges.

10. The metal stud of claim 9, wherein the foldable spikes support wall linings.

11. The metal stud of claim 9, wherein the lowest foldable spike is truncated to form a support tab.

12. The metal stud of claim 1, wherein each flange further comprise a wall lining sheet support tab on the lower end of the stud.

13. The metal stud of claim 1, wherein the stud further comprises brick tie fixing holes spaced appropriately along the stud.

14. The metal stud of claim 13, wherein the stud has indents on the intersection between the web and flanges adjacent to the brick tie holes to assist in locating said holes.

15. The metal stud of claim 3, wherein the web plate tabs further comprise a plurality of nail tooth spikes formed integrally with said tabs.

16. The metal stud of claim 3, wherein the web plate tabs further comprise two indented ribs to lock the web plate tab in the folded position.

17. The metal stud of claim 1, wherein the flange plate tabs further comprise a plurality of nail tooth spikes formed integrally with said tabs.

18. The metal stud of claim 1, wherein the flange plate tabs further comprise a plurality of fastener holes.

19. The metal stud of claim 1, wherein the flange plate tabs have extensions formed in the plane of said flange plate tabs and said extensions are foldable.

20. The metal stud of claim 1, wherein the tabs further comprise indents formed along the fold lines.

21. The metal stud of claim 1, wherein the tabs further comprise notches and scores to assist folding.

22. A hybrid building frame system comprising:
a plurality of metal studs each comprising: an elongated metal section including two flanges joined by a web; flange and web plate tabs formed at each end of the stud, said web plate tabs foldable from a position in a plane of the web to a position generally perpendicular to the web;
and one or more further foldable tabs being formed along the stud;
timber top plates attachable to said metal studs at upper said flange and web plate tabs;
timber bottom plates attachable to said metal studs at lower said flange and web plate tabs; and
timber lintels, sills and noggins attachable between said studs at said one or more further tabs.

23. The hybrid building frame system of claim 22, wherein the timber top plates are the same width as the distance between the flanges of the stud.

24. The hybrid building frame system of claim 22, wherein the timber bottom plates are the same width as the distance between the flanges of the stud.

25. The hybrid building frame system of claim 22, wherein the lintels, sills and noggins are the same width as the distance between the flanges of the stud.

26. The hybrid building frame system of claim 22, wherein the timber top plates, bottom plates, lintels, sills and noggins are the same width as the distance between the outer surfaces of the stud flanges and are stepped down in width in the region where they join onto the stud to fit between the stud flanges.

27. The hybrid building frame system of claim 22, wherein two adjacent metal studs are configured in a back-to-back fashion.

28. The hybrid building frame system of claim 22, wherein two adjacent metal studs are configured in a piggy-back fashion.

29. The hybrid building frame system of claim 22, wherein two adjacent metal studs are configured in a face-to-face fashion creating a cavity between said studs.

30. The hybrid building frame system of claim 29, wherein short timber blocks are fixed in the cavity between the metals studs.

31. A method of constructing a hybrid building frame including the steps of:
attaching a metal stud to a timber bottom plate, by fixing said bottom plate between lower flanges of said stud;
attaching a metal stud to a timber top plate, by fixing said top plate between upper flanges of said stud; and
attaching one or more noggins, sills and or lintels between adjacent metal studs with noggins, sills and or lintels fixed to said studs;

32. The method of claim 31, wherein the timber top plate rests on top of the foldable web plate tab and is fastened with nails or screws through holes in the upper flange plate and web plate tabs.

33. The method of claim 31, wherein the timber bottom plate is fastened with nails or screws to the metal stud through holes in the lower flange plate and web plate tabs.

34. The method of claim 31, wherein one or more noggins, lintels and sills rest on noggin, lintel and sill support tabs and are fixed in position with nails or screws to the metal stud through holes in the adjacent stud flanges, web and support tabs.

35. The method of claim 31, further including the step of driving nail tooth spikes formed integrally with said flange plate tabs and web plate tabs into said timber top plate to secure said top plate.

36. The method of claim 31, further including the step of driving nail tooth spikes formed integrally with said flange plate tabs and web plate tabs into said timber lower plate to secure said lower plate.

37. The method of claim 31, further including the step of driving offset nail tooth spikes formed integrally with said upper web plate tab and said upper flange plate tabs inwards into said upper wall plate until flush with said upper web tab and said upper flange tabs respectively with said offset nail tooth spikes being bent inwards into the plane of said web tab and said flange tabs respectively at fold lines at the upper ends of each said nail tooth spike.

38. The method of claim 31, further including the step of driving offset nail tooth spikes formed integrally with said lower web plate tab and said lower flange plate tabs inwards into said lower wall plate until flush with said lower web tab and said lower flange tabs respectively with said offset nail tooth spikes being bent inwards into the plane of said web tab and said flange tabs respectively at fold lines at the upper ends of each said nail tooth spike.

39. The method of claim 31, further including the step of driving nail tooth spikes formed integrally with said upper web plate tab and said upper flange plate tabs by bending said upper web plate tab and said upper flange plate tabs into said upper wall plate with said nail tooth spikes being flush to said upper web plate tab and said flange plate tabs respectively.

40. The method of claim 31, further including the step of driving nail tooth spikes formed integrally with said lower web plate tab and said lower flange plate tabs by bending said lower web plate tab and said lower flange plate tabs into said lower wall plate with said nail tooth spikes being flush to said lower web plate tab and said flange plate tabs respectively.

41. The method of claim 31, wherein the stud has flange plate tabs formed in the plane of the flange that extend beyond the wall plate and are folded around the said wall plate encasing and supporting it.

42. A brick tie for use in a hybrid building frame system, said brick tie comprising:
a length of shaped wire including a body;
a stud attachment portion at one end of the body, said stud attachment portion consisting of a bent section forming a crank that interlocks with a hole in the stud;
a wall engagement portion at the other end of the body; and
a moisture elimination portion intermediate the stud attachment portion and the wall engagement portion.

43. The brick tie of claim 42, wherein the stud attachment portion comprises a crank in the form of a first short length extending generally perpendicular to the longitudinal axis of the body of said wire and a second length extending generally parallel to the longitudinal axis of the body of said wire from an end of said first short length distal from the body.

44. The brick tie of claim 43, wherein the stud attachment portion further comprises a third length generally perpendicular to the longitudinal axis of the body of the wire and extending from a free end of said second length.

45. The brick tie of claim 42, wherein the wall engagement portion comprises a bent portion adapted to be held in mortar laid between courses of bricks forming a wall.

46. The brick tie of claim 42, wherein the wall engagement portion is bent in a wave shape.

47. The brick tie of claim 42, wherein the wall engagement portion is formed by a single bend in the wire in a plane of a mortar course between bricks forming a wall.

48. The brick tie of claim 42, wherein the moisture elimination portion is an N shape section bent in the wire.

49. The brick tie of claim 48, wherein the N shaped moisture elimination section is aligned in a vertical plane when in use.

50. The brick tie of claim 42, wherein the brick tie is formed from stainless steel wire.

51. The brick tie of claim 42, wherein the stud attachment portion and the wall engagement portion are formed in a generally horizontal plane.
